(19) United States
(12) Patent Application Publication
(10) Pub. No.: US 2011/0256869 A1
(43) Pub. Date: Oct. 20, 2011

(54) PEER-TO-PEER ASSISTED NETWORK SEARCH

(76) Inventors: Qin Zhang, Mountain View, CA (US); Jason Shi, Pleasanton, CA (US)

(21) Appl. No.: 12/760,323

(22) Filed: Apr. 14, 2010

(51) Int. Cl. H04W 48/18

(52) U.S. Cl. 455/435.2

(57) ABSTRACT

Methods, program products, and systems of peer-to-peer assisted network searching are disclosed. In general, in one aspect, a first mobile device can request cellular connectivity configuration information from one or more second mobile devices over a personal area network. The first mobile device can receive the cellular connectivity configuration information from the one or more second mobile devices. From the received cellular connectivity configuration information, the first mobile device can identify a cellular connectivity configuration that is compatible with the first mobile device. The first mobile device can select a cellular network to connect to using the identified cellular connectivity configuration.

### TECHNICAL FIELD

This disclosure relates generally to configuring a mobile device.

### BACKGROUND

A modern mobile device can incorporate functions of a computer, of a cellular transceiver, or a wireless (e.g., WiFi™) transceiver. For example, the mobile device can perform traditional computer functions, such as executing application programs, storing various data, and displaying digital images. These functions can be performed in an application subsystem of the mobile device. The application subsystem can include an application processor, an application operating system, and various input/output devices.

When the mobile device functions as a cellular transceiver, the mobile device can initiate and receive phone calls, send and receive data over a cellular network, identify cellular tower connections, and determine when and whether to switch cellular towers. Similarly, the mobile device can function as a wireless radio transceiver and send and received data over a wireless network, e.g. a WiFi™ network. These radio-related functions can be performed in a baseband subsystem of the mobile device. The baseband subsystem can include a baseband processor and a baseband operating system. The baseband processor can be an integrated circuit (IC) device (e.g., a Large Scale Integrated Circuit (LSI)) that performs communication functions. The baseband processor can include, for example, a Global System for Mobile Communications (GSM) modem. The baseband processor can be can be integrated with the application processor in a System-on-Chip (SoC). In general, the application subsystem can consume more power than the baseband subsystem when activated.

### SUMMARY

Methods, program products, and systems of peer-to-peer assisted network searching are disclosed. In general, in one aspect, a first mobile device can request cellular connectivity configuration information from one or more second mobile devices over a personal area network. The first mobile device can receive the cellular connectivity configuration information from the one or more second mobile devices. From the received cellular connectivity configuration information, the first mobile device can identify a cellular connectivity configuration that is compatible with the first mobile device. The first mobile device can select a cellular network to connect to using the identified cellular connectivity configuration.

The details of one or more implementations of peer-to-peer assisted network search are set forth in the accompanying drawings and the description below. Other features, aspects, and advantages of peer-to-peer assisted network search will become apparent from the description, the drawings, and the claims.

### BRIEF DESCRIPTION OF THE DRAWINGS

FIG. 1 provides an overview of an exemplary peer-to-peer assisted network search.

FIG. 2 illustrates information passed between mobile devices during a peer-to-peer assisted network search.

FIG. 3 is a block diagram illustrating exemplary components of a mobile device configured to perform peer-to-peer assisted network search.

FIG. 4 illustrates an exemplary data structure of information used in peer-to-peer assisted network search.

FIG. 5 illustrates an exemplary user interface for configuring a mobile device to provide peer-to-peer assistance for network search.

FIGS. 6A and 6B are flowcharts illustrating exemplary processes of peer-to-peer assisted network search.

FIG. 7 is a block diagram illustrating an exemplary device architecture of a mobile device implementing the features and operations described in reference to FIGS. 1-6.

FIG. 8 is a block diagram of an exemplary network operating environment for the mobile devices of FIGS. 1-7.

Like reference symbols in the various drawings indicate like elements.

### DETAILED DESCRIPTION

Overview of Peer-to-Peer Assisted Network Search

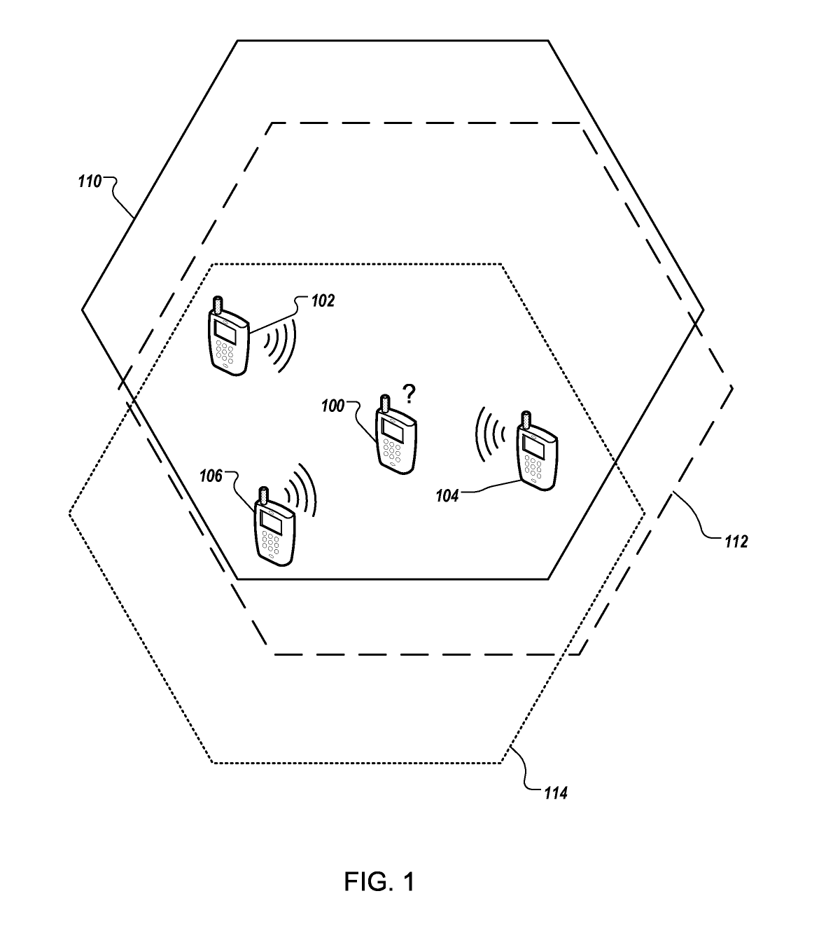

FIG. 1 provides an overview of an exemplary peer-to-peer assisted network search. In the example shown in FIG. 1, mobile devices 100 can request and receive peer-to-peer assistance when performing the network search.

Mobile device 100 can include a baseband subsystem that monitors a cellular communications network. The baseband subsystem can determine whether to switch from one wireless communication gateway (e.g., a cell tower) to another wireless communication gateway, or from one network to another network. Mobile device 100 can be registered to a network service provider, or network operator, such that mobile device 100 can operate in a particular cellular network of the network operator (e.g., a home network). Mobile device 100 can travel (e.g., roam) to an area that is outside the home network. During roaming, mobile device 100 can attempt to connect to a second network (e.g., a visited network) as a visitor. The visited network can determine that no entry of mobile device 100 exists in a home subscriber register of the visited network. Example home subscriber registers can include a Home Location Register (HLR) in a Global System for Mobile Communications (GSM) networks, or local customer database in a wireless local area network (WLAN).

The visited network, upon detecting a presence of mobile device 100, and noticing that mobile device 100 is not registered with the visited network, can attempt to identify the home network of mobile device 100. If there is no roaming agreement between the home network and the visited network, the visited network can deny service to mobile device 100. If a roaming agreement exists, the visited network can contact the home network and request service information about mobile device 100, including whether or not mobile device 100 is allowed to roam. Upon a positive response, the visited network can maintain a temporary subscriber record for mobile device 100. The home network can update information on mobile device 100 to indicate that mobile device 100 is on the visited network so that any information sent to mobile device 100 can be correctly routed.

Mobile device 100 can determine which networks are available by scanning various networks. When mobile device 100 is located at a location (e.g., a foreign country) where radio access technologies (RAT) are different from that of the home network, mobile device 100 may need to perform the scan using various access technologies, over various bands, in various frequencies. The scanning can be time consuming when multiple networks, multiple technologies, and multiple bands are available.

For example, mobile device 100, having a home network in San Francisco, United States, can travel to Tokyo, Japan. Various cellular networks operated by various operators (e.g., NTT DoCoMo, au, or SoftBank Mobile) using various technologies can be available in Tokyo. The technologies can include personal digital cellular (PDC), universal mobile telecommunications system (UMTS), code division multiple access (e.g., CDMA 2000 1X). Geographic areas of coverage of the networks can overlap. For example, mobile device 100 can be located in cell 110 of a first network, cell 112 of a second network, and cell 114 of a third network. Mobile device 100 can determine which cell tower of cells 110, 112, and 114 to connect to.

Mobile device 100 can intelligently determine which network and which cell tower to connect to. Mobile device 100 can perform a search of the networks. For example, mobile device 100 can scan various channels using various access technology compatible with mobile device 100. If a channel of a particular network is identified, mobile device 100 can send a notification of a presence of mobile device 100 to the network through the channel, such that the network can determine whether to provide service to mobile device 100. If no service is available from a particular network, mobile device 100 can continue scanning in an attempt to find the next network.

Mobile device 100 can utilize peer-to-peer assistance to reduce time for the search. Prior to or during the search, mobile device 100 can seek peer-to-peer assistance from other mobile devices (e.g., mobile devices 102, 104, and 108). Mobile device 100 can seek peer-to-peer assistance at any time, including at a time where home network is not available. Mobile device 100 can broadcast a request for peer-to-peer assistance to nearby mobile devices (e.g., mobile devices 102, 104, and 106) using a wireless protocol (e.g., Bluetooth™) over a personal area network (PAN) that is proximate to mobile device 100. The request can be broadcast automatically, or upon user request.

At lease some of mobile devices 102, 104, and 106 can respond to the request by broadcasting network configuration information. Mobile devices 102, 104, and 106 can be mobile devices that are connected to the various networks that mobile device 100 is attempting to search. The network configuration information can include the technology used in the networks, the channels, bands, and frequencies that are being used, by mobile devices 102, 104, and 106. In some implementations, the network configuration information can include a RAT identifier, a mobile country code (MCC), a mobile network code (MNC), a public land mobile network (PLMN) code that includes both the MCC and the MNC, a location area code (LAC), and a cell ID of the cellular communication network to which a mobile device is connected.

Mobile device 100 can receive the network configuration information and use the network configuration to optimize the search for an available network. For example, mobile device 100 can receive a response identifying that W-CDMA, band 1, frequency 1, and public land mobile network operator PLMN 1 being used by a second mobile device. Mobile device 100 can limit the search to networks using W-CDMA technology if mobile device 100 is compatible with W-CDMA. By searching the network using knowledge gained from the received network configuration information, mobile device 100 can reduce the time needed to identify and connect to a network.

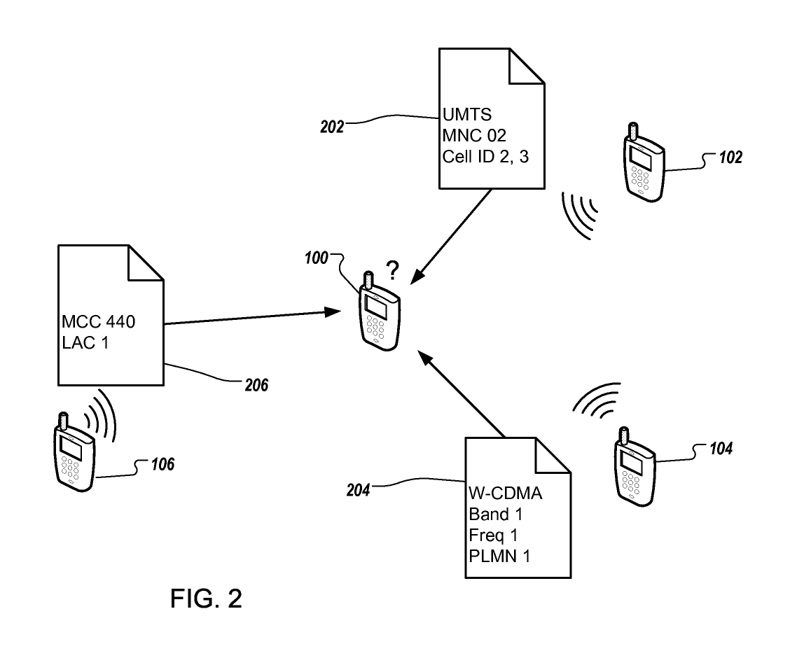

FIG. 2 illustrates the information passed between mobile devices during a peer-to-peer assisted network search. Mobile device 100 can broadcast a request for peer-to-peer assistance for network search. In response to the request, mobile devices 102, 104, and 106 can each send network configuration information that contain different data fields.

For example, mobile device 102 can respond by sending network configuration information 202, which can include information on technology used by a first cellular network to which mobile device 102 is connected in a RAT identifier (e.g., “UMTS”). Configuration information 202 can also include an MNC of the network (e.g., “MNC 02”), and the most recently connected cell IDs of the cells (e.g., “cell ID 2” and “cell ID 3”). Mobile device 100 can perform a search using technology specified in the received RAT identifier to search the cellular networks. Additionally or alternatively, mobile device 100 can determine priority of the search of networks based on whether a network operator identified by the MNC has a service agreement with the home network of mobile device 100. Mobile device 100 can determine a priority of search of cells based on the most recent cell IDs received from mobile device 102.

MNC (e.g., “MNC 02” received from mobile device 102), in itself, may not be sufficient for identifying a network operator. An MCC may be necessary. The MCC can be missing from network configuration information 202 due to a user configuration, a faulty transmission of network configuration information 202, or other reasons. Mobile device 100 can combine network configuration information 202 with network configuration information 206 from mobile device 106 in order to determine which network operator is available. Network configuration information 206 can include an MCC (e.g., “MCC 440” for Japan). Combining the MCC received in network configuration information 206 with the MNC received in network configuration information 102 to identify the network operator. For example, mobile device 100, based on “MCC 440” in combination with “MNC 02,” can determine that the network operator is NTT DoCoMo.

Mobile device 100 can receive network configuration information 204 from mobile device 104. Network configuration information 204 can include a RAT identifier (e.g., “W-CDMA”) from a network, and band, frequency, and PLMN information currently used or last used by mobile device 104. Mobile device 100 can identify that RAT identifiers “W-CDMA” and “UMTS” are synonyms. Mobile device 100 can store the information while performing a first search using the network configuration information 202 and 206 received from mobile devices 102 and 106, individually or in combination. If that search does not result in finding a network that can provide service, mobile device 100 can perform a second search using the stored information. If none of the received network configuration information can result in finding a network that can provide service, or if no assistance is received, mobile device 100 can perform the service using all technologies, bands, and frequencies.

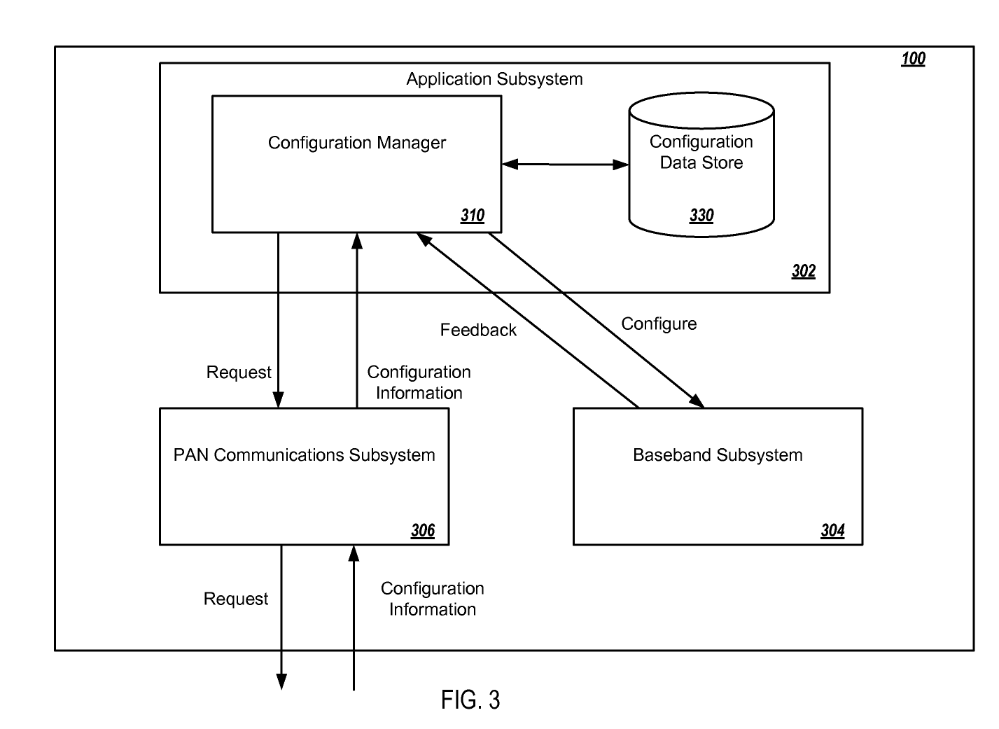

FIG. 3 is a block diagram illustrating exemplary components of mobile device 100 configured to perform peer-to-peer assisted network search. Mobile device 100 can include, among other components, application subsystem 302, baseband subsystem 304, and PAN communications subsystem 306.

Application subsystem 302 can include an application operating system and an application processor. Configuration manager 306 can execute in application subsystem 302. Configuration manager 310 can communicate with baseband subsystem 304 and PAN communication subsystem 306.

When mobile device 100 is turned on or enters an active mode, for example, when mobile device 100 exits an “airplane” mode in which communications functions are turned off, baseband subsystem 304 can be activated to seek a wireless communications network (e.g., a cellular network). Configuration manager 310 can be activated to seek peer-to-peer assistance for the network search.

Configuration manager 310 can submit a request to PAN communications subsystem 306 to seek assistance from peers (e.g., other mobile devices) that are located in the PAN. PAN communications subsystem 306 can include a PAN operating system and a PAN processor for communicating with other mobile devices using wireless PAN standards (e.g., an Institute of Electrical and Electronics Engineers (IEEE) standard that belongs to IEEE 802.15x family). Upon receiving the request from configuration manager 310, PAN communications subsystem 306 can broadcast the request and receive network configuration information from various mobile devices. PAN communications subsystem 306 can send the information to configuration manager 310. The network configuration information need not be received all at once. PAN communications subsystem 306 can receive network configuration information from one mobile device earlier than another device.

Configuration manager 310 can store the network configuration information received from PAN communications subsystem 306 in configuration data store 330. The network configuration information can be stored in various data fields to allow network configuration information received from one mobile device to be combined with network configuration information received from another mobile device such that a complete PLMN can be derived. For example, if configuration manager 310 receives an MNC without an MCC, configuration manager 310 can store the MNC in configuration data store 330. When configuration manager 310 receives an MCC later, configuration manager 310 can combine the MCC and MNC to identify a network operator.

Upon identifying one or more network operators, configuration manager 310 can determine a search order by which baseband subsystem 304 can perform the search for a network. The search order can be based on various factors. For example, a search strategy can include prioritizing various technologies according to compatibility of the technologies with mobile device 100. A search strategy can specify which network to search first based on whether the network has roaming agreement with the home network of mobile device 100. The search order can specify, for example, that the network charging the least roaming fees to be searched first. Various fee schedules and a list of one or more networks that have roaming agreement with the home network can be stored in configuration data store 330. Data store 330 can additionally or alternatively store a user-configured search order that specifies a user preference as to which network is to be searched first.

Configuration manager 310 can configure baseband subsystem 304 to search the network based on the search order. When baseband subsystem 304 finds a network and a frequency to use, baseband subsystem 304 can provide feedback to configuration manager 310 to allow configuration manager 310 to stop requesting or receiving peer-to-peer assistance.

The search for a network by baseband subsystem 304 can take an amount of time during which configuration manager 310 can receive additional network configuration information from mobile devices. When the additional network configuration information indicates a network, or a band, or a frequency, that ranks lower in the search order than the current network, band, or frequency being searched by baseband subsystem 304, configuration manager 310 can store the additional network configuration information in configuration data store 330. If baseband subsystem 304 finds a network to connect to, the additional information need not be used. If baseband subsystem 304 fails to find a network, or the network found by baseband subsystem 304 refuses to provide service to mobile device 100, baseband subsystem 304 can provide feedback to configuration manager 310, informing configuration manager 310 of the failure. Configuration manager 310 can configure baseband subsystem 304 to search an additional network, band, or frequency using the additional information.

When the additional network configuration information indicates a network, or a band, or a frequency, that ranks higher in the search order than the current network, band, or frequency being searched by baseband subsystem 304, configuration manager 310 can configure baseband subsystem 304 to interrupt the current search and perform a new search using the additional network configuration information. Information of the current search, including configuration parameters, can be stored in configuration data store 330. If the new search fails, configuration manager 310 can configure baseband subsystem 304 to continue performing the interrupted search.

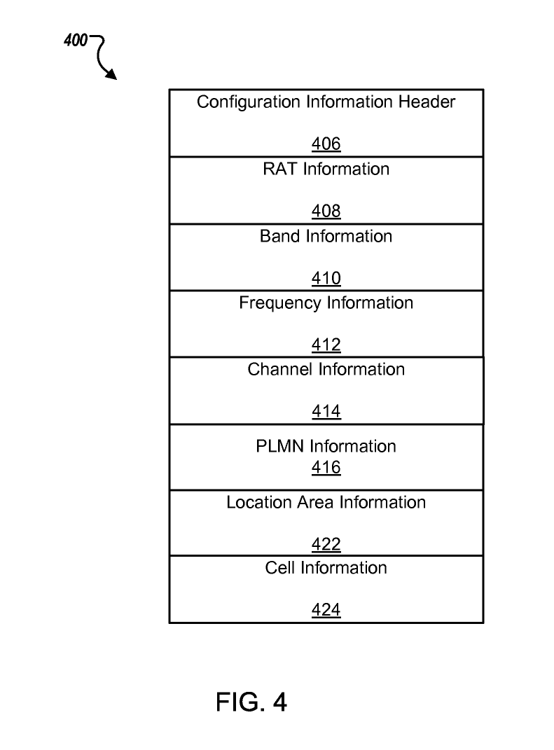

FIG. 4 illustrates exemplary data structure 400 of information used in peer-to-peer assisted network search. Data structure 400 can be used to define network configuration information transmitted between mobile devices, peer-to-peer, in a PAN. For convenience, data structure 400 will be described with reference to mobile device 102, which can respond to a peer-to-peer assistance request by transmitting data organized in data structure 400.

Data structure 400 can include configuration information header field 406, which can store a header. The header can include a timestamp of the transmission, a timestamp indicating when data fields in data structure 400 was last changed, and geographic coordinates of mobile device 102. Data structure 400 can include RAT information data field 408, which can be used to specify a RAT identifier (e.g., a label) that describes what radio access technology (e.g., “UMTS”) is used by mobile device 102.

Band information data field 410 can be used to specify which frequency band is used in a network using the RAT. For example, band information data field 410 can indicate that mobile device 102 operates in frequency band 2100, which can indicate that a user equipment (UE) transmit frequency range is between 1920 and 1980 megahertz (MHz), and a UE receive frequency range is between 2110 and 2170 MHz. Frequency information data field 412 can be used to specify a current frequency being used by mobile device 102. Channel information data field 414 can include information on a current channel number. The current channel number can be a universal mobile telephony system terrestrial radio access absolute radio frequency channel number (UARFCN), for example, between channel 9612 and 9888. PLMN data field 416 can be used to specify an MCC and an MNC, which, in combination, can uniquely identify a network operator.

In some implementations, data structure 400 can allow data of PLMN data field 416 to include only MCC information or only MNC information, such that MCC and MNC can be transmitted separately. Thus, a user of mobile device 102 can configure mobile device 102 to provide peer-to-peer assistance to other mobile devices without revealing what network operator is used by mobile device 102.

Data structure 400 can further include location area information data field 422, which can be used to specify a LAC, and cell information data field 424, which can be used to specify a current cell ID. Not all information needs to be provided for all data fields during a peer-to-peer assistance of a network search. A mobile device (e.g., mobile device 100) receiving partial information from multiple mobile devices providing assistance can assemble the partial information.

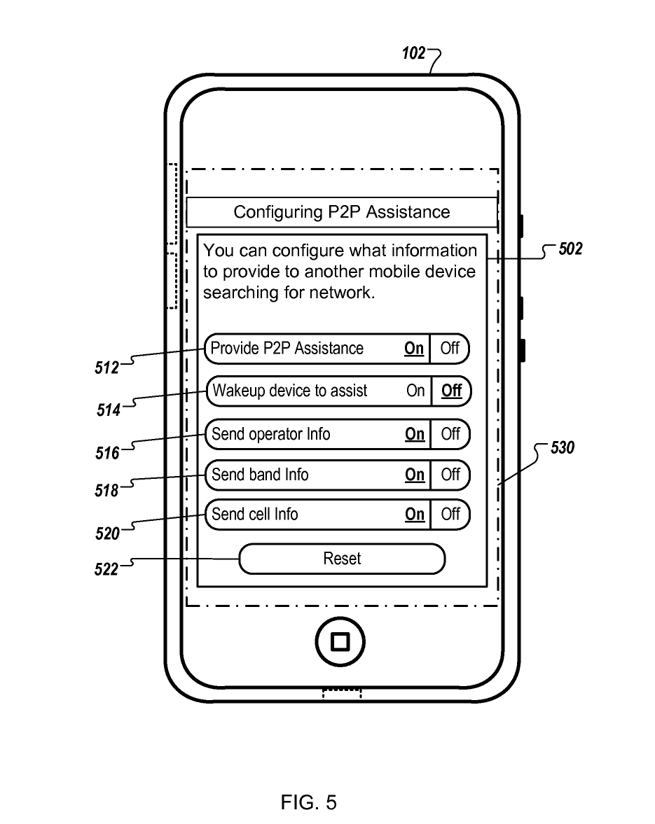

FIG. 5 illustrates exemplary user interface 502 for configuring a mobile device to provide peer-to-peer assistance for network search. For convenience, the user interface will be described with respect to mobile device 102 that implements the user interface.

A user can configure mobile device 102 to provide or not to provide peer-to-peer assistance to other mobile devices (e.g., mobile device 100). Mobile device 102 can be configured through user interface 502 that is presented on display device 530 of mobile device 102. Mobile device 102 can include, for example, a handheld computer, a personal digital assistant, a cellular telephone, an electronic tablet, a network appliance, a camera, a smart phone, an enhanced general packet radio service (EGPRS) mobile phone, a network base station, a media player, a navigation device, an email device, a game console, or a combination of any two or more of these data processing devices or other data processing devices. Display device 530 can include a multi-touch sensitive screen that can receive user inputs.

User interface 502 can be invoked, for example, when mobile device 102 receives a touch input through display device 530 in a “set up” screen. User interface 502 can include control 512 for determining whether to provide peer-to-peer (P2P) assistance for network searching to another mobile device requesting the assistance. The peer-to-peer service will be provided if the control is set to an “on” position, e.g., by a user touching a switch displayed in control 512 and flip the switch to the “on” position.

User interface 502 can include control 514 for determining whether to activate an application subsystem (e.g., application subsystem 302) in order to provide the peer-to-peer assistance. Mobile device 102 can include an application subsystem that has an active mode and a power-saving (or standby, or sleep) mode. Generally, the application subsystem can consume more power in the active mode than in the power-saving mode. To conserve battery power of mobile device 102, the application subsystem can be set to the power-saving mode after a threshold period of time of idling (e.g., one minute). In the power-saving mode, non-essential components of the application subsystem can be temporarily suspended. For example, an image of volatile memory, if any, can be cached on non-volatile storage device, and power supply to the volatile memory can be disconnected. Non-essential parts of the core of the application processor can be turned off. The clock of the processor can be slowed down. A subsystem for monitoring a PAN (e.g., PAN communications subsystem 306) can be kept “on” constantly or intermittently. Thus, the subsystem for monitoring the PAN can receive a request for peer-to-peer assistance when the application subsystem is in a power-saving mode.

When control 514 is set to “on,” the subsystem for monitoring the PAN can activate the application subsystem to provide the assistance, even if the application subsystem is in a power-saving mode. When control 514 is set to “off,” the subsystem for monitoring the PAN can request the assistance from the application subsystem only when the application subsystem is in active mode. If the application subsystem is in power-saving mode, the application subsystem will not be invoked.

In some implementations, the subsystem for monitoring the PAN can directly interact with a baseband subsystem (e.g., baseband subsystem 304) to acquire network configuration information and broadcast the network configuration information upon receiving a request.

User interface 502 can include controls 516, 518, and 520 for configuring mobile device 102 as to whether to send operator information (e.g., MNC), band information, and cell information, respectively, in a response to request for assistance. Controls 516, 518 and 520 can allow a user of mobile device 102 to prevent other users (e.g., a user using a device requesting assistance) from acquiring knowledge on which network the user has been using, what frequency is being used by mobile device 102, and in which cell mobile device 102 is (or was) located.

User interface 502 can include reset control 522 that allows the user to delete the configurations set up by the user and set the peer-to-peer assistance settings to default values (e.g., factory values when mobile device 102 was shipped).

### Exemplary Processes of Peer-to-Peer Assisted Network Search

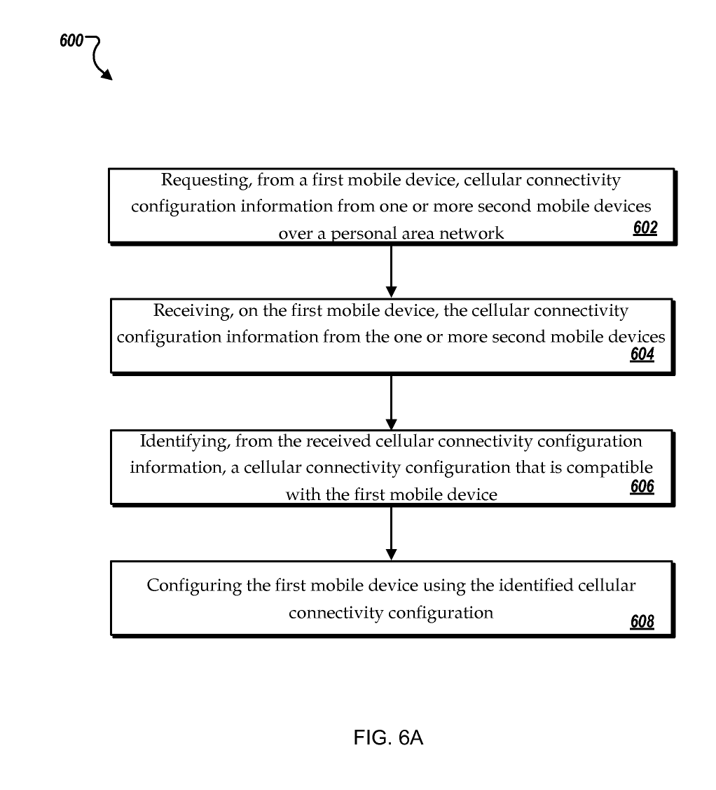

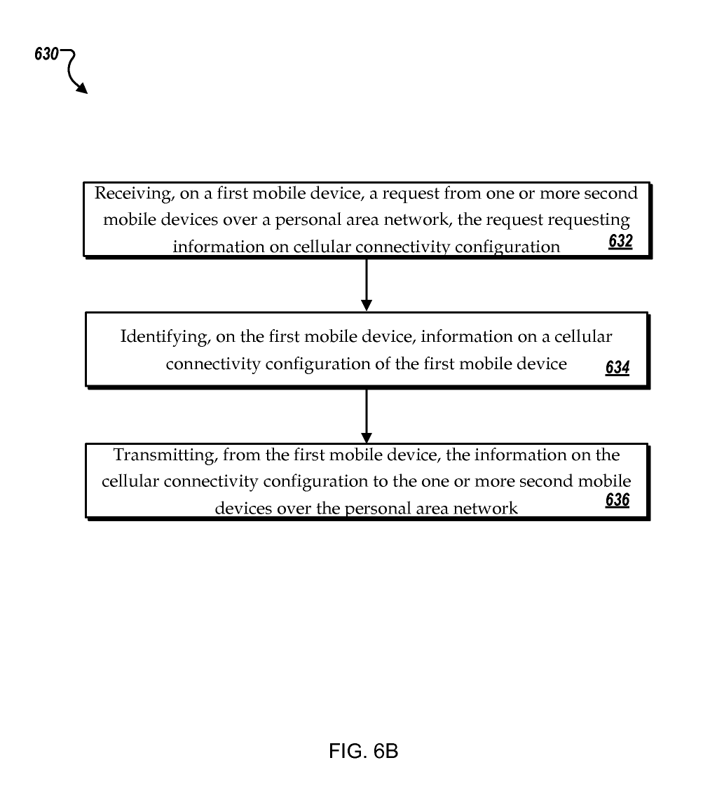

FIGS. 6A and 6B are flowcharts illustrating exemplary processes 600 and 630, respectively, of peer-to-peer assisted network search. FIG. 6A illustrates exemplary process 600 of requesting and receiving peer-to-peer assistance for network search. For convenience, process 600 will be described in reference to mobile device 100 that implements process 600.

Mobile device 100 can request (602) cellular connectivity configuration information from one or more second mobile devices (e.g., mobile devices 102, 104, or 106) over a personal area network. The cellular connectivity configuration information includes at least one of an MCC, a UARFCN, an ARFCN, and a RAT identifier. In some implementations, the MCC can be specified in PLMN information data field 416 of data structure 400. The UARFCN and ARFCN can be specified in channel information data field 414. The RAT identifier can be specified in RAT information data field 408.

In some implementations, cellular connectivity configuration information further includes a set of cell IDs of radio cells that are within communication range of the second mobile devices. Each second mobile device (e.g., mobile device 102) can respond to the request by sending to mobile device 100 a current cell ID, or a list of cell IDs most recently used by the second mobile device. The cellular connectivity configuration information further includes a band identifier and a frequency identifier. The band identifier can be stored in band information data field 410 of data structure 400. The frequency identifier can be stored in frequency information data field 412.

Mobile device 100 can receive (604) the cellular connectivity configuration information from the one or more second mobile devices (e.g., mobile devices 102, 104, and 106).

Mobile device 100 can identify (606), from the received cellular connectivity configuration information, a cellular connectivity configuration that is compatible with the mobile device 100. Identifying the cellular connectivity configuration can include identifying a cellular network that has a roaming agreement with a home network of mobile device 100. The cellular connectivity configuration information includes signal strength values of cells of various cellular networks. The signal strength values can be specified in cell information data field 424, in association with cell IDs. Identifying the cellular connectivity configuration can include selecting a particular cell of a particular cellular network, the cell being a cell of the cellular network whose service provider is in the list of registered service providers, and the cell being associated with a strongest signal strength value.

Mobile device 100 can automatically configure (608) mobile device 100 using the identified cellular connectivity configuration. Automatically configuring mobile device 100 can include determining a network search strategy using the identified cellular connectivity configuration. The network strategy can include prioritizing networks and channels for search.

FIG. 6B illustrates exemplary process 630 of providing peer-to-peer assistance for network search. For convenience, process 630 will be described in reference to mobile device 102 that implements process 630.

A first mobile device (e.g., mobile device 102) can receive (632) a request from one or more second mobile devices (e.g., mobile device 100) over a PAN (e.g., a Bluetooth™ network), the request requesting cellular connectivity configuration information. Mobile device 102 and the second mobile devices can be peers in the PAN. For example, mobile device 102 and the second mobile devices can be distributed in the PAN such that mobile device 102 and the second mobile devices can exchange data with one another through mutual data exchange (e.g., without using central coordination from a server).

Mobile device 102 can identify (634) cellular connectivity configuration information of mobile device 102. The cellular connectivity configuration information can be identified directly from a baseband subsystem, or from the baseband subsystem through an application subsystem. The cellular connectivity configuration information can include at least one of an MCC, a UARFCN, an ARFCN, and a RAT identifier.

Mobile device 102 can transmit (636) the cellular connectivity configuration information to the one or more second mobile devices over the personal area network. The transmission can by made through a broadcast.

### Exemplary Mobile Device Architecture

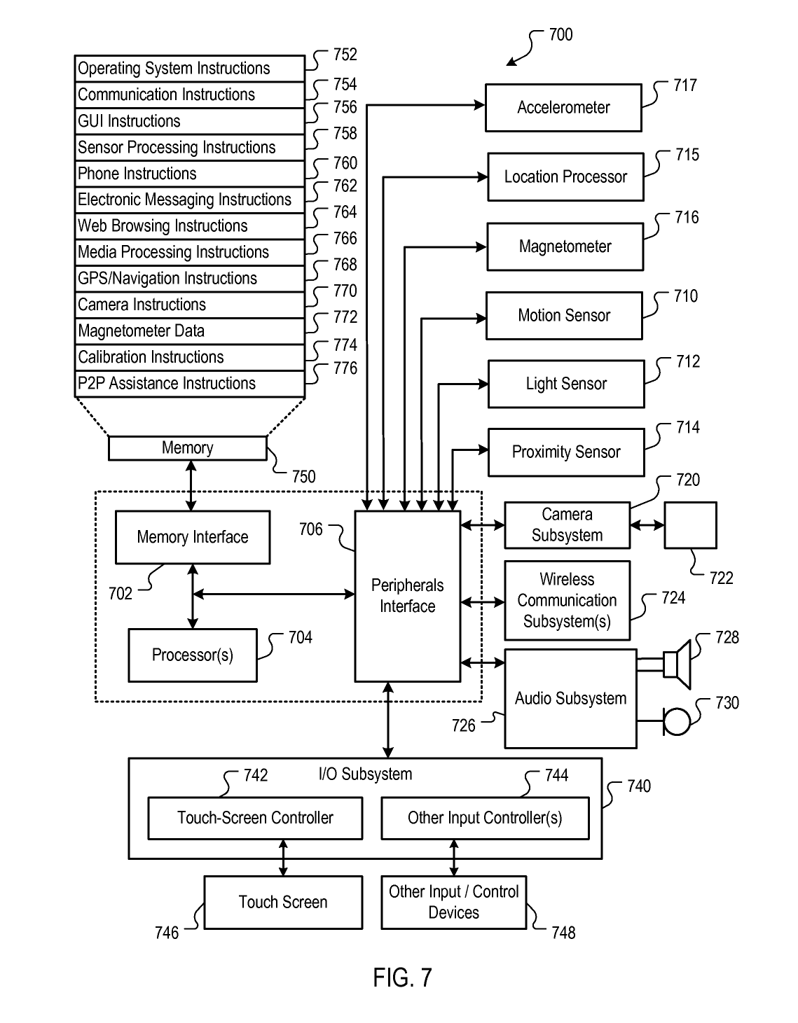

FIG. 7 is a block diagram of an exemplary architecture 700 for the mobile devices of FIGS. 1-6. A mobile device (e.g., mobile device 100) can be, for example, a handheld computer, a personal digital assistant, a cellular telephone, an electronic tablet, a network appliance, a camera, a smart phone, an enhanced general packet radio service (EGPRS) mobile phone, a network base station, a media player, a navigation device, an email device, a game console, or a combination of any two or more of these data processing devices or other data processing devices.

Mobile device 100 can include memory interface 702, one or more data processors, image processors and/or processors 704, and peripherals interface 706. Memory interface 702, one or more processors 704 and/or peripherals interface 706 can be separate components or can be integrated in one or more integrated circuits. Processors 704 can include application processors (APs) and baseband processors (BPs). The various components in mobile device 100, for example, can be coupled by one or more communication buses or signal lines.

Sensors, devices, and subsystems can be coupled to peripherals interface 706 to facilitate multiple functionalities. For example, motion sensor 710, light sensor 712, and proximity sensor 714 can be coupled to peripherals interface 706 to facilitate orientation, lighting, and proximity functions of the mobile device. Location processor 715 (e.g., GPS receiver) can be connected to peripherals interface 706 to provide geopositioning. Electronic magnetometer 716 (e.g., an integrated circuit chip) can also be connected to peripherals interface 706 to provide data that can be used to determine the direction of magnetic North. Thus, electronic magnetometer 716 can be used as an electronic compass. Accelerometer 717 can also be connected to peripherals interface 706 to provide data that can be used to determine change of speed and direction of movement of the mobile device.

Camera subsystem 720 and an optical sensor 722, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which a mobile device is intended to operate. For example, a mobile device can include communication subsystems 724 designed to operate over a GSM network, a GPRS network, an EDGE network, a Wi-Fi or WiMax network, and a Bluetooth™ network. In particular, the wireless communication subsystems 724 can include hosting protocols such that the mobile device can be configured as a base station for other wireless devices.

Audio subsystem 726 can be coupled to a speaker 728 and a microphone 730 to facilitate voice-enabled functions, such as voice recognition, voice replication, digital recording, and telephony functions.

I/O subsystem 740 can include touch screen controller 742 and/or other input controller(s) 744. Touch-screen controller 742 can be coupled to a touch screen 746 or pad. Touch screen 746 and touch screen controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 746.

Other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of speaker 728 and/or microphone 730.

In one implementation, a pressing of the button for a first duration may disengage a lock of the touch screen 746; and a pressing of the button for a second duration that is longer than the first duration may turn power to mobile device 100 on or off. The user may be able to customize a functionality of one or more of the buttons. The touch screen 746 can, for example, also be used to implement virtual or soft buttons and/or a keyboard.

In some implementations, mobile device 100 can present recorded audio and/or video files, such as MP3, AAC, and MPEG files. In some implementations, mobile device 100 can include the functionality of an MP3 player, such as an IPod™ Mobile device 100 may, therefore, include a pin connector that is compatible with the iPod. Other input/output and control devices can also be used.

Memory interface 702 can be coupled to memory 750. Memory 750 can include high-speed random access memory and/or non-volatile memory, such as one or more magnetic disk storage devices, one or more optical storage devices, and/or flash memory (e.g., NAND, NOR). Memory 750 can store operating system 752, such as Darwin, RTXC, LINUX, UNIX, OS X, WINDOWS, or an embedded operating system such as VxWorks. Operating system 752 may include instructions for handling basic system services and for performing hardware dependent tasks. In some implementations, operating system 752 can include a kernel (e.g., UNIX kernel).

Memory 750 may also store communication instructions 754 to facilitate communicating with one or more additional devices, one or more computers and/or one or more servers. Memory 750 may include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes and instructions; camera instructions 770 to facilitate camera-related processes and functions; magnetometer data 772 and calibration instructions 774 to facilitate magnetometer calibration. The memory 750 may also store other software instructions (not shown), such as security instructions, web video instructions to facilitate web video-related processes and functions, and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 750. Memory 750 can include peer-to-peer assistance instructions 776 that can be used to request, receive, and provide peer-to-peer assistance from and to other mobile devices (e.g., peers) in a personal area network. Peer-to-peer assistance instructions 776 can include instructions for determine a network search strategy based on network configuration information received from one or more pears in the personal area network.

Each of the above identified instructions and applications can correspond to a set of instructions for performing one or more functions described above. These instructions need not be implemented as separate software programs, procedures, or modules. Memory 750 can include additional instructions or fewer instructions. Furthermore, various functions of the mobile device may be implemented in hardware and/or in software, including in one or more signal processing and/or application specific integrated circuits.

### Exemplary Operating Environment

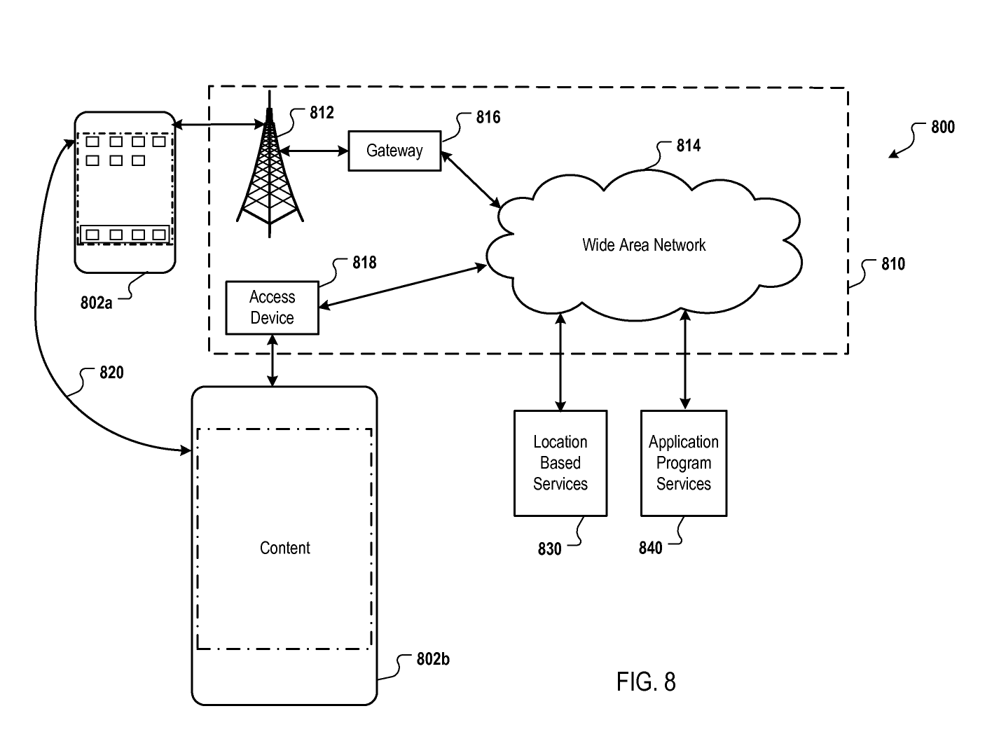

FIG. 8 is a block diagram of an exemplary network operating environment 800 for the mobile devices of FIGS. 1-7. Mobile devices 802a and 802b can, for example, communicate over one or more wired and/or wireless networks 810 in data communication. For example, a wireless network 812, e.g., a cellular network, can communicate with a wide area network (WAN) 814, such as the Internet, by use of a gateway 816. Likewise, an access device 818, such as an 802.11g wireless access device, can provide communication access to the wide area network 814.

In some implementations, both voice and data communications can be established over wireless network 812 and the access device 818. For example, mobile device 802a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 812, gateway 816, and wide area network 814 (e.g., using Transmission Control Protocol/Internet Protocol (TCP/IP) or User Datagram Protocol (UDP)). Likewise, in some implementations, the mobile device 802b can place and receive phone calls, send and receive e-mail messages, and retrieve electronic documents over the access device 818 and the wide area network 814. In some implementations, mobile device 802a or 802b can be physically connected to the access device 818 using one or more cables and the access device 818 can be a personal computer. In this configuration, mobile device 802a or 802b can be referred to as a “tethered” device.

Mobile devices 802a and 802b can also establish communications by other means. For example, wireless device 802a can communicate with other wireless devices, e.g., other mobile devices 802a or 802b, cell phones, etc., over the wireless network 812. Likewise, mobile devices 802a and 802b can establish peer-to-peer communications 820, e.g., a personal area network, by use of one or more communication subsystems, such as the Bluetooth™ communication devices. Other communication protocols and topologies can also be implemented.

The mobile device 802a or 802b can, for example, communicate with one or more services 830 and 840 over the one or more wired and/or wireless networks. For example, one or more location registrations services 830 can provide various services, including functions and application programs, to mobile devices 802. The services can be based on where mobile devices 802 are located.

Application program service 840 can, for example, provide application programs for download to mobile device 802. The application programs can include application programs that facilitate peer-to-peer assisted network search.

Mobile device 802a or 802b can also access other data and content over the one or more wired and/or wireless networks. For example, content publishers, such as news sites, Really Simple Syndication (RSS) feeds, web sites, blogs, social networking sites, developer networks, etc., can be accessed by mobile device 802a or 802b. Such access can be provided by invocation of a web browsing function or application (e.g., a browser) in response to a user touching, for example, a Web object.

A number of implementations of the invention have been described. Nevertheless, it will be understood that various modifications can be made without departing from the spirit and scope of the invention. For example, a personal area network is disclosed where peer-to peer assistance is provided. Other form of networks, e.g., WLAN, can be used. A mobile device that requests and receives peer-to-peer assistance is described in reference to mobile device 100. A mobile device that provides peer-to-peer assistance is described in reference to mobile device 102. Each of mobile devices 100 and 102 can both request/receive and provide peer-to-peer assistance.

What is claimed is:

1. A method executed by a first mobile device, comprising:
requesting cellular connectivity configuration information from one or more second mobile devices over a personal area network;
receiving, on the first mobile device, the cellular connectivity configuration information from the one or more second mobile devices;
identifying, from the received cellular connectivity configuration information, a cellular connectivity configuration that is compatible with the first mobile device; and
configuring the first mobile device using the identified cellular connectivity configuration.

2. The method of claim 1, wherein the cellular connectivity configuration information includes at least one of a mobile country code (MCC), a mobile network code (MNC), a public land mobile network (PLMN) code, a universal mobile telephony system terrestrial radio access absolute radio frequency channel number (UARFCN), an absolute radio frequency channel number (ARFCN), and a radio access technology (RAT) identifier.

3. The method of claim 2, wherein the cellular connectivity configuration information further includes a set of cell identifiers (cell IDs) of radio cells that are within communication range of the second mobile devices.

4. The method of claim 2, wherein the cellular connectivity configuration information further includes a band identifier and a frequency identifier.

5. The method of claim 1, wherein identifying the cellular connectivity configuration includes identifying a cellular network that has a roaming agreement with a home network of the first mobile device.

6. The method of claim 5, wherein the cellular connectivity configuration information includes signal strength values of cells of various cellular networks.

7. The method of claim 6, wherein identifying the cellular connectivity configuration includes selecting a particular cell of a particular cellular network, the cell being a cell of the cellular network whose service provider is in a list of registered service providers, and the cell being associated with a strongest signal strength value.

8. A method executed by a first mobile device, comprising:
receiving a request from one or more second mobile devices over a personal area network, the request requesting cellular connectivity configuration information;
identifying, on the first mobile device, cellular connectivity configuration information of the first mobile device; and
transmitting, from the first mobile device, the cellular connectivity configuration information to the one or more second mobile devices over the personal area network.

9. The method of claim 8, wherein the cellular connectivity configuration information includes at least one of a mobile country code (MCC), a mobile network code (MNC), a public land mobile network (PLMN) code, a universal mobile telephony system terrestrial radio access absolute radio frequency channel number (UARFCN), an absolute radio frequency channel number (ARFCN), and a radio access technology (RAT) identifier.

10. A system, comprising:
a first mobile device, the first mobile device configured to perform operations comprising:
requesting cellular connectivity configuration information from one or more second mobile devices over a personal area network;
receiving, on the first mobile device, the cellular connectivity configuration information from the one or more second mobile devices;
identifying, from the received cellular connectivity configuration information, a cellular connectivity configuration that is compatible with the first mobile device; and
configuring the first mobile device using the identified cellular connectivity configuration.

11. The system of claim 10, wherein the cellular connectivity configuration information includes at least one of a mobile country code (MCC), a mobile network code (MNC), a public land mobile network (PLMN) code, a universal mobile telephony system terrestrial radio access absolute radio frequency channel number (UARFCN), an absolute radio frequency channel number (ARFCN), and a radio access technology (RAT) identifier.

12. The system of claim 11, wherein the cellular connectivity configuration information further includes a set of cell identifiers (cell IDs) of radio cells that are within communication range of the second mobile devices.

13. The system of claim 11, wherein the cellular connectivity configuration information further includes a band identifier and a frequency identifier.

14. The system of claim 10, wherein identifying the cellular connectivity configuration includes identifying a cellular network that has a roaming agreement with a home network of the first mobile device.

15. A system, comprising:
a first mobile device, the first mobile device configured to perform operations comprising:
receiving a request from one or more second mobile devices over a personal area network, the request requesting cellular connectivity configuration information;
identifying, on the first mobile device, cellular connectivity configuration information of the first mobile device; and
transmitting, from the first mobile device, the cellular connectivity configuration information to the one or more second mobile devices over the personal area network.

16. The system of claim 15, wherein the cellular connectivity configuration information includes at least one of a mobile country code (MCC), a mobile network code (MNC), a public land mobile network (PLMN) code, a universal mobile telephony system terrestrial radio access absolute radio frequency channel number (UARFCN), an absolute radio frequency channel number (ARFCN), and a radio access technology (RAT) identifier.

17. A computer program product stored on a storage device, operable to cause a first mobile device to perform operations comprising:
requesting cellular connectivity configuration information from one or more second mobile devices over a personal area network;
receiving, on the first mobile device, the cellular connectivity configuration information from the one or more second mobile devices;
identifying, from the received cellular connectivity configuration information, a cellular connectivity configuration that is compatible with the first mobile device; and
configuring the first mobile device using the identified cellular connectivity configuration.

18. The product of claim 17, wherein the cellular connectivity configuration information includes at least one of a mobile country code (MCC), a mobile network code (MNC), a public land mobile network (PLMN) code, a universal mobile telephony system terrestrial radio access absolute radio frequency channel number (UARFCN), an absolute radio frequency channel number (ARFCN), and a radio access technology (RAT) identifier.

19. The product of claim 18, wherein the cellular connectivity configuration information further includes a set of cell identifiers (cell IDs) of radio cells that are within communication range of the second mobile devices.

20. The product of claim 18, wherein the cellular connectivity configuration information further includes a band identifier and a frequency identifier.
